(19) United States
(12) Patent Application Publication
(10) Pub. No.: US 2015/0227964 A1
(43) Pub. Date: Aug. 13, 2015

(54) Revenue Estimation through Ensemble Modeling

(71) Applicant: Adobe Systems Incorporated, San Jose, CA (US)

(72) Inventors: Zhenyu Yan, Sunnyvale, CA (US); Praveen Krishnakumar, Chennai (IN); Abhishek Pani, San Francisco, CA (US); Anil Kamath, Los Altos Hills, CA (US); Suman Basetty, Fremont, CA (US); Kunal Kumar Jain, Chennai (IN)

(73) Assignee: Adobe Systems Incorporated, San Jose, CA (US)

(21) Appl. No.: 14/177,385

(22) Filed: Feb. 11, 2014

(51) Int. Cl. G06Q 30/02

(52) U.S. Cl. CPC G06Q 30/0244; G06Q 30/0247; G06Q 30/0277

(57) ABSTRACT

An ensemble model is described that is usable to predict revenue metrics for one or more keywords. The ensemble model may be formed using both a historical model and a user behavior model. In one or more implementations, weights are assigned to the historical model and/or the user behavior model based on one or more criteria. Various processing techniques of the ensemble model may utilize the historical model and the user behavior model to predict revenue metrics for one or more keywords.

### BACKGROUND

Avertising on the Internet has become an increasingly effective way to market products and services. However, development of an online marketing strategy that maximizes return may be challenging as advertisers often utilize predicted returns to decide on which opportunities should receive an investment.

For example, conventional techniques may track events occurring in association with keywords entered in a search engine to predict potential revenue associated with the keywords. However, in some instances this data may be sparse and thus may not function to accurately predict revenue, thus causing inconsistencies and advertiser frustration.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

An ensemble model is described that predicts revenue metrics for one or more keywords. In one or more implementations, an ensemble model is formed using both a historical model and a user behavior model. The historical model may include historical data indicative of revenue generated from previous advertising instances associated with a keyword whereas the user behavior model may include data describing online user behavior associated with the keyword. In one or more implementations, weights are assigned to the historical model and/or the user behavior model based on sparsity of the historical data used to form the historical model. For example, if the historical data is rich (e.g., represents a high likelihood of accurately predicting revenues for the keyword), then a higher weight is assigned to the historical model relative to the weight assigned to the user behavior model.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 depicts a representation of a scenario in an example implementation in which the ensemble model predicts revenue metrics for a keyword.

FIG. 3 is a flow diagram depicting a procedure in which the ensemble model predicts revenue metrics for the one or more keywords.

FIG. 4 is a flow diagram depicting a procedure for predicting revenue metrics for one or more keywords based at least in part on a weighted historical model and a weighted user behavior model.

FIG. 5 is a flow diagram depicting a procedure in which a user behavior model and a historical model are generated to predict revenue metrics for one or more keywords.

FIG. 6 illustrates an example system including an example device that is representative of one or more computing systems and/or devices that may implement the various techniques described herein.

### DETAILED DESCRIPTION

Overview

Conventional techniques that are utilized to predict revenues for keywords may not be accurate, thereby resulting in loss of opportunities to advertisers and search engine providers. For example, conventional models often depend on prediction of revenues for a keyword based on conversion data associated with the keyword. As such, predicted revenues for some keywords are simply not accurate due to sparseness of data that may be utilized to generate the prediction. Thus, conventional models may not be well suited to accurately predict revenues for keywords.

Revenue estimation techniques for keywords are described. In one or more implementations, an ensemble model is described that is usable to predict revenue metrics for one or more keywords. For example, an ensemble model may be formed using both a historical model and a user behavior model. The historical model may include historical data indicative of revenue generated from previous advertising instances (e.g., a displayed advertisement, a displayed webpage, a displayed search result, a promoted webpage, and so forth) associated with a keyword. The user behavior model may include data describing online user behavior associated with the keyword (e.g., time spent on webpage, webpage viewed, bounce rate, and so forth after users click the advertisement associated with the keyword). By assigning weights to the historical model and/or the user behavior model that form the ensemble model, the ensemble model may be utilized to predict revenue metrics for one or more keywords even in instances in which data utilized to generate the historical model is sparse.

Weights may be assigned to the historical model and/or the user behavior model in a variety of ways. For example, the weights may be assigned based on sparsity of historical data (e.g., impressions, clicks, costs, conversions, and so forth) used to form the historical model. If the historical data is rich (e.g., represents a high likelihood of accurately predicting revenues for the keyword), for instance, then a higher weight may be assigned to the historical model relative to the weight assigned to the user behavior model. In another example, weights may be assigned to the historical model and/or the user behavior model based on an amount of available historical data. For instance, if the amount of available historical data is below a threshold, then a lower weight may be assigned to the historical model relative to the weight assigned to the user behavior model. Additionally or alternatively, weights may be assigned to the historical model and/or the user behavior model based on a confidence value indicative of a likelihood of accuracy of the historical data.

Multiple data sources may be used to obtain data for inclusion in the ensemble model. For instance, one data source may provide historical data while another data source may provide online behavior data, e.g., time spent on webpage, webpage viewed, bounce rate, and so forth. Further, multiple different data sources may be accessed to obtain more than one set of historical data and/or more than one set of online behavior data. Each set of historical data and/or online behavior data obtained from the multiple different data sources may then be used to produce one predictive model. The multiple predictive models from the multiple data sets will eventually make up the ensemble model. For example, given a keyword in a search query, there is one set of historical data obtained from one data source and two sets of online user behavior data obtained from two different data sources. Then three predictive models will be built and eventually ensembled through appropriate weights.

Additionally, historical data and/or online behavior data may be collected from multiple data sources for a subset of keywords. For example, historical data maybe collected from one data source for each of multiple keywords whereas online behavior data may be collected from another data source for a subset of the multiple keywords. Alternatively, historical data may be collected from one data source for a subset of multiple keywords whereas online behavior data may be collected from another data source for each of the multiple keywords. A variety of other examples are also contemplated, further discussion of which may be found in the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

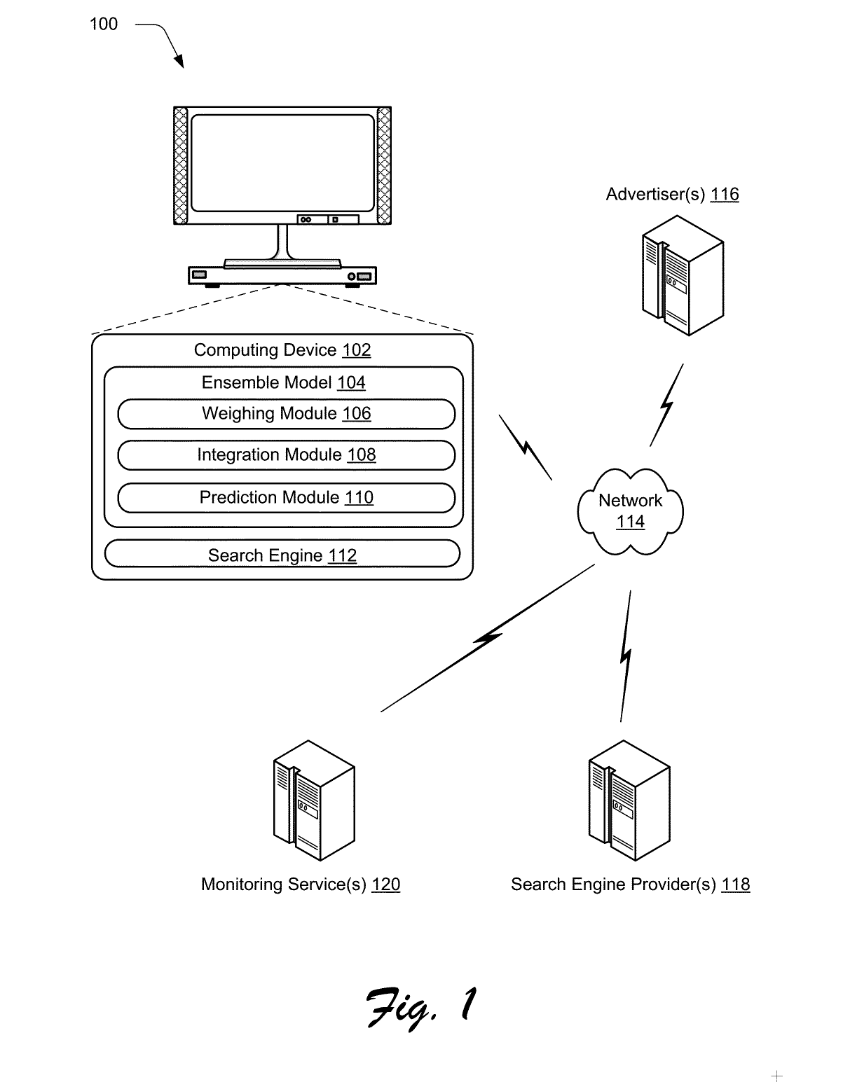

FIG. 1 is an illustration of an environment 100 in an example implementation that is operable to employ techniques described herein. The illustrated environment 100 includes a computing device 102 which comprises an ensemble model 104, a weighing module 106, an integration module 108, a prediction module 110, and a search engine 112. The illustrated environment 100 further includes, a network 114, advertisers 116, search engine providers 118, and monitoring services 120. The advertisers 116, search engine providers 118, and monitoring services 120 may be implemented using one or more computing devices, e.g., a server farm, “in the cloud,” and so on.

The ensemble model 104 is representative of functionality to predict revenues for one or more keywords and may be formed using a plurality of models. The ensemble model 104, for instance, may employ a weighing module 106 to assign weights to the models that form the ensemble model 104 based in part on the predicted revenues of each respective model. The weights assigned to the models may then be used by the integration module 108 to integrate the predicted revenues. The prediction module 110 may then predict revenue metrics for the one or more keywords based on this integration.

By way of example and not limitation, assume that a user entered “men's suits” into a search engine. Advertisers of men's suits may wish to bid for presenting an advertisement in association with the keywords “men's suits” and may base their bid on predicted revenue results. In this example, historical conversion data associated with “men's suits” may be processed as part of a historical model such that, after processing the conversion data, a predicted revenue result is output based on the historical data. Thus, the historical model may be utilized to describe past interaction with the keywords. In addition, behavior data associated with “men's suits” may be processed as part of a behavior model such that, after processing, another predicted revenue result is output based on the behavior data. The behavior data may describe user behavior associated with the keywords and thus may be utilized to describe other interactions that are not limited to historical data. Thus, the results output from the multiple predictive models may be based on data from different data sources e.g., receiving the conversion data and behavior data from different data sources. These outputs may then serve as inputs into the ensemble model 104.

Generally, the ensemble model 104 may employ the weighing module 106, the integration module 108, and/or the prediction module 110 to process the inputs (e.g., the results output from the multiple predictive models) to output one or more revenue values indicative of potential revenue, such as for “men's suits” in this example. For instance, the weighing module 106 (e.g., a mathematical module that may be implemented in hardware, firmware, software, or a combination thereof) may assign weights to the multiple predictive models and/or the results output therefrom, e.g., the behavior model and the historical model. In the ongoing example, because the historical data is rich (e.g., represents a high likelihood of accurately predicting revenues for “men's suits”), then a higher weight is assigned to the historical model relative to the weight assigned to the user behavior model. Alternatively, if the keywords had instead been “men's space suits” and behavior data (e.g., time spent on a space suit web page was greater relative to other men's suits web pages), then a higher weight is assigned to the user behavior model relative to the weight assigned to the historical model. In some embodiments, the weighing module 106 may receive as an input the results output from the multiple predictive models and output a respective weighting value. Further examples of functionality performed by the weighing module 106 may be found above and below.

Processing of the inputs of the ensemble model 104 may include integrating the weights assigned to the multiple predictive models and/or the results output therefrom by the integration module 108. Returning to the ongoing example, the integration module 108 may receive as an input the respective weight values associated with the historical model and the user behavior model and output a single predicted revenue value for “men's suits”. Further examples of functionality performed by the integration module 108 may be found above and below.

Additionally or alternatively, processing of the inputs of the ensemble model 104 may include predicting revenue metrics for one or more keywords (e.g., “men's suits”) by the prediction module 110. For example, the prediction module 110 (e.g., a mathematical module that may be implemented in hardware, firmware, software, or a combination thereof) may predict one or more revenue values indicative of potential revenue for “men's suits”. That is, the prediction module 110 may receive as an input the single predicted revenue value resultant from the integrating and output the one or more revenue values indicative of potential revenue for “men's suits”. The one or more revenue values indicative of potential revenue for “men's suits” may then be shared with advertisers to better enable the advertisers to bid for presenting an advertisement in association with the keywords “men's suits”. The one or more revenue values resultant from the processing of the ensemble model 104 provide the advertisers a more accurate prediction for potential revenue as compared to the predictions of conventional models.

Further examples of functionality performed by the prediction module 110 may be found above and below.

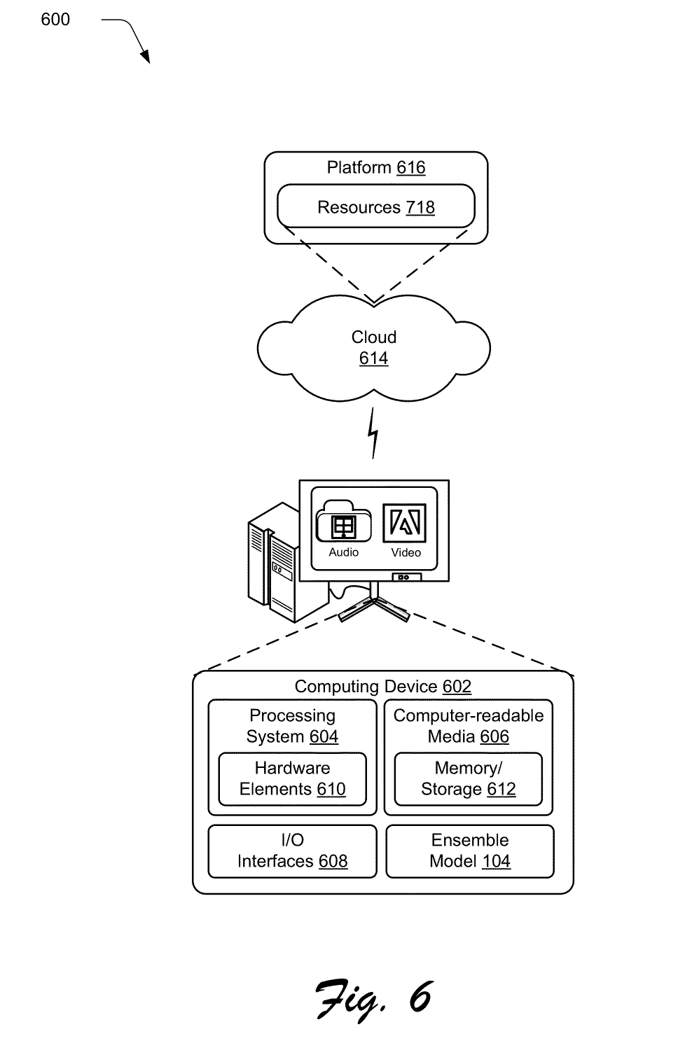

Generally, any of the functions described herein can be implemented using software, firmware, hardware (e.g., fixed logic circuitry), or a combination of these implementations. The terms “model,” “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors, as further described in FIG. 6.

The computing device 102, for instance, may be configured as a desktop computer, a laptop computer, a mobile device (e.g., assuming a handheld configuration such as a tablet or mobile phone), and so forth. Thus, the computing device 102 may range from full resource devices with substantial memory and processor resources (e.g., personal computers, game consoles) to a low-resource device with limited memory and/or processing resources, e.g., mobile devices. Additionally, although a single computing device 102 is shown, the computing device 102 may be representative of a plurality of different devices, such as multiple servers utilized by a business to perform operations “over the cloud” as further described in relation to FIG. 6.

Online marketing strategies may be utilized to maximize return to advertisers 116 as well as search engine providers 118 relating to advertising instances, e.g., a displayed advertisement, a displayed webpage, a displayed search result, a promoted webpage, and so forth. For example, advertisers 116 may develop an online marketing strategy along with partners, such as search engine providers or companies specializing in analytics as represented by the monitoring services 120. Take an example in which an advertiser 116 and a search engine provider 118 work together to determine value for presenting an advertisement associated with a keyword used in a search query. Here, the search engine provider 118 may provide keyword revenue data (clicks or costs) to the advertiser 116 enabling the advertiser 116 to make investment decisions regarding advertising instance opportunities relating to keywords. Likewise, such information may also be obtained from a monitoring service 120. In addition to providing revenue data, the search engine provider 118 may also provide summary reports to the advertiser, often daily, based on an analysis of the revenue data.

However, revenue data, alone, may be limited and therefore fail to provide enough useful information for making an investment decision in some instances. For example, the accuracy of the predictive/estimation model built on the revenue data provided by the search engine provider 118 typically depends on an amount of available data. In circumstances when the keyword is well known, for instance, conversion data associated with the keyword may be utilized to produce an accurate estimate for predicting revenues. However, in circumstances when the keyword is not well known, conversion data associated with the keyword may not, alone, be sufficient for accurately estimating its revenue. This is particularly the case when the keyword is a long tail keyword, e.g., a narrow keyword or a keyword with a limited number of associated clicks. Thus, online marketing strategies may lose accuracy in predicting revenues for a keyword when data is scarce, e.g., an amount of conversion data available for the keyword is low or non-existent.

One technique that may be utilized to improve the accuracy of predicted revenues for a keyword having scarce data involves extrapolating conversion data from potentially related keywords. For example, to produce a more meaningful prediction for a keyword having scarce data, techniques may be employed to build a prediction model from conversion data of similar keywords. Here, a hierarchy of keywords may be grouped such that any of the similar keywords in the keyword group may be used in the prediction model. The prediction model, however, then depends on data that may or may not have a direct or meaningful relationship with the keyword having scarce data.

Additionally, multiple predictive models (e.g., a historical model and a user behavior model) may be integrated as an ensemble model 104 thereby supplementing a prediction that results from only a single model based on a single data source. For instance, given a keyword having scarce data available for predicting revenue and/or building a prediction model, additional data from an additional data source may be utilized to supplement the prediction model by building a new prediction model from the additional data. The additional data may, in some cases, describe user behavior associated with the keyword (either directly or indirectly) or conversion behavior associated with the keyword. Additionally or alternatively, the additional data used to build a new prediction model may be obtained from a data source that does not track conversion data.

For example, the computing device 102 may receive a keyword from a user and predict, via the ensemble model 104, revenue metrics for the keyword. In one or more implementations, the user may enter a search query into the search engine 112 causing the monitoring service 120 to track events associated with the keyword. Unlike conventional techniques, data usable by the ensemble model 104 for predicting revenue metrics may be obtained from multiple diverse models and/or multiple data sources, such as the advertisers 116, the search engine providers 118, and/or the monitoring services 120 via network 114. The predicted revenue metrics for the keyword may be shared with the advertisers 116 and/or the search engine providers 118 via network 114 to enable decisions on which opportunities related to the keyword should receive an investment.

By building an ensemble model 104 that considers more than one prediction model, predicted revenues and reports, advertisers 116 may have increased accuracy over conventional techniques, thereby supporting informed investments decision and increased returns. Because the ensemble model 104 combines data from two different models and/or data from two different sources, advertisers 116 are not required to analyze data from one model while trying to make sense of how other available data may serve their investment decisions. The number of reports sent to an advertiser may also be reduced because the ensemble model 104 may be utilized to synthesize data and generate a single report rather than providing a report for each prediction stemming from different data.

Consequently, advertisers 116 that receive predicted revenues, or other revenue metrics as described herein, may make use of the ensemble model 104 to improve a rate of return using revenue metrics. For example, the advertiser 116 may rely on the revenue metrics when bidding on a keyword for the purpose of associating a particular advertisement. Relative to conventional techniques, the revenue metrics determined by the ensemble model 104 may also be useful in improving income to the advertiser via conversions, purchases, and/or orders.

The ensemble model 104 is illustrated as including a weighing module 106, an integration module 108, and a prediction module 110. The ensemble model 104 is operable to employ techniques for predicting or estimating revenue metrics for one or more keywords. The one or more keywords, for instance, may be associated with the search engine 112, e.g., entered as a search query. For example, the ensemble model 104 may predict revenue metrics (e.g., revenue per click and the like) by combining keyword prediction results from different revenue models. Additionally or alternatively, the ensemble model 104 may predict revenue metrics by processing data from multiple different data sources (e.g., storage local to the computing device 102, the advertisers 116, the search engine providers 118, the monitoring services 120, a remote server (not shown), and/or a remote database (not shown)). By way of example and not limitation, the data from each of the multiple different data sources may be inconsistent, incompatible, and/or heterogeneous relative to each other.

The ensemble model 104 may be configured in a manner that is different from a Bayesian model. That is, the ensemble model 104 uses multiple diverse models to improve predictive performance than could be obtained from any one of the multiple diverse models. The multiple diverse models may be stored on the computing device 102, the monitoring services 120, a remote server (not shown), and/or a remote or local database (not shown).

The weighing module 106 is representative of functionality to assign weights to different revenue models. For example, the weighing module 106 may assign a weight to a historical model (e.g., an endogenous model) and/or a user behavior model (e.g., an exogenous model) that form the ensemble model 104. In this example, weights may be assigned to the historical model and/or the user behavior model based on sparsity of historical data used to form the historical model, an amount of available historical data, and/or a confidence value indicative of a likelihood of accuracy of the historical data. A variety of other examples are also contemplated, further discussion of which may be found in the following sections.

The weighing module 106 may also assign weights to predicted revenues determined by different revenue models. For example, the weighing module 106 may receive predicted revenue values from the different revenue models and assign a weight to each of the predicted revenue values based on a confidence value indicative of a likelihood of accuracy of each predicted revenue value. In determining a weight to assign to the predicted revenue values, the weighing module 106 may also consider a location of the data source (e.g., remote, local, or third-party) from which the data is obtained, sparsity of the data, and/or an amount of available data from the data source.

For example, if a keyword is a long tail keyword (e.g., a narrow keyword or a keyword with a limited number of associated clicks), historical data associated with the long tail keyword may be sparse in which case the weighing module 106 assigns a higher weight to the prediction generated from the model based on the online user behavior data associated with the long tail keyword relative to the weight assigned to the prediction generated from the model based on historical data associated with the long tail keyword.

The integration module 108 may integrate or combine revenue models, and/or predicted revenues determined by different revenue models obtained from multiple data sources. The integration performed by the integration module 108 may be based on a variety of factors, such as the weights assigned by the weighing module 106. In one or more implementations, the integration module 108 may integrate or combine the revenue models, and/or the predicted revenues determined by different revenue models built on the sets of data obtained from multiple data sources by applying common statistical algorithms, such as bagging, bootstrap aggregating, boosting, and so forth.

The prediction module 110 may predict or estimate revenue metrics for one or more keywords. The prediction module 110 may predict the revenue metrics for the one or more keywords by analyzing and/or comparing results of the integrating module 108. The results of the integrating module 108 may, for example, be analyzed for validation or accuracy prior to being used as a predicted revenue metric. Additionally or alternatively, the prediction module 110 may, for instance, compare a predicted revenue value received from the integrating module 108 with a previously determined revenue metric prior to determining that the predicted revenue value is to be shared with the advertisers 116. In one or more implementations, the prediction module 110 may predict revenue metrics for short tail keywords (e.g., broad or well-known keywords) or long tail keywords.

Although the ensemble model 104 is illustrated as being implemented on the computing device 102 it should be readily apparent that other implementations are also contemplated in which the ensemble model 104 is implemented on a separate device such as a remote server, a local server, or other remote computing device. Further, although illustrated as being provided by a computing device 102 in a desktop configuration, a variety of other configurations are also contemplated, such as remotely over a network 114 as part of a web platform as further described in relation to FIG. 6. Regardless of where implemented, the ensemble model 104 is representative of functionality that may be configured to predict revenue metrics for one or more keywords.

The search engine 112 may be any application configured to enable receiving a search query. The search query received by the search engine 112 of the computing device 102 may be sent to the search engine providers 118 via network 114 to receive search results. In addition, because one or more keywords of the search query may be of interest to the advertisers 116, the one or more keywords may be sent to the monitoring services 120 via network 114 for tracking, analyzing, and so forth. Advertisements in various forms may be sent from the advertisers 116 to the search engine 112 for storage and/or presentation. An advertisement from the advertisers 116 may be selected for sending to the search engine 112 based on the revenue metrics predicted from the ensemble model 104.

The network 114, meanwhile, represents any one or combination of multiple different types of wired and/or wireless networks, such as cable networks, the Internet, private intranets, and so forth. While FIG. 1 illustrates the computing device 102 communicating with the advertisers 116, the search engine providers 118, and/or the monitoring services 120 over the network 114, the techniques may apply in any other networked or non-networked architectures.

The illustrated environment 100 further includes the advertisers 116, the search engine providers 118, and the monitoring services 120 each of which may exchange data with the computing device 102 via the network 114. For example, the advertiser 116 and the search engine provider 118 may receive predicted revenue metrics for one or more keywords from the computing device 102. The monitoring service 120 (e.g., a service utilizing analytics and/or tracking tools) may receive a keyword from the computing device 102 and track advertising instances (e.g., online advertising instances) associated with the keyword. In some instances, the advertiser 116, the search engine provider 118, and/or the monitoring service 120 may send data to the computing device 102 usable by the ensemble model 104. For example, the monitoring service 120 may send data describing advertising instances associated with a keyword to the computing device 102. In one or more implementations, the monitoring service 120 may be a third-party service that stores data that correlates impressions, clicks, costs, conversions, and so forth to a particular keyword. Additionally or alternatively, the monitoring service 120 may store data describing time spent on webpage, webpage viewed, and/or bounce rate associated with a particular keyword.

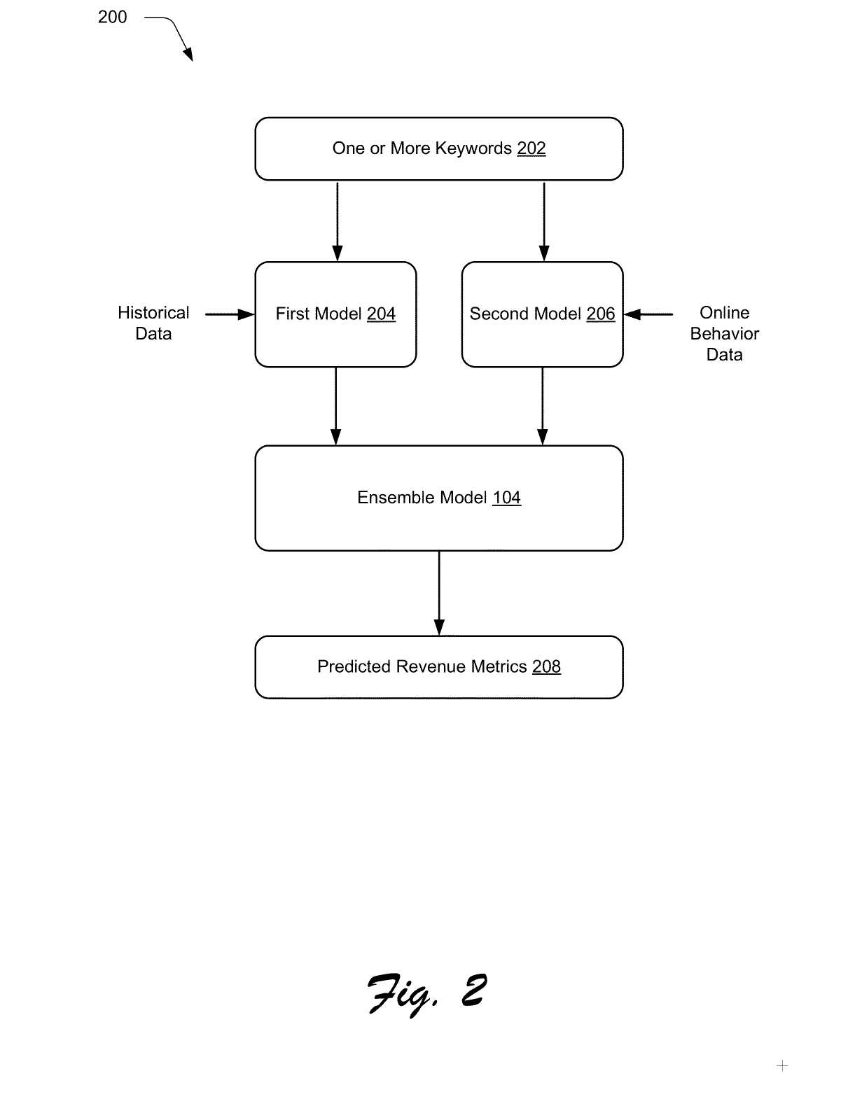

FIG. 2 depicts generally at 200 a representation of a scenario in an example implementation in which the ensemble model 104 of FIG. 1 predicts revenue metrics for a keyword. As represented in FIG. 2, one or more keywords 202 are provided to a first model 204 and a second model 206. The first model 204 and/or the second model 206 may be representative of a mathematical model that may be implemented as a module such as in hardware, firmware, software, or a combination thereof. Responsive to the first model 204 and the second model 206 receiving the one or more keywords 202, each of the models concurrently obtain different data from different data sources. The ensemble model 104 may combine the first model 204 and the second model 206 (or predicted revenues generated by each respective model) and generate predicted revenue metrics 208 for the one or more keywords 202.

As illustrated, the one or more keywords 202 provided to the first model 204 and the second model 206 may include a short tail keyword, a long tail keyword, a keyword entered as a search query of a search engine, a keyword entered as a search query of an application, or a combination thereof. The one or more keywords 202 may include a short tail keyword(s) and a long tail keyword(s).

The first model 204 may obtain historical data associated with the one or more keywords. In examples when the one or more keywords includes at least two keywords, the first model 204 may obtain historical data for a subset of the at least two keywords. As used throughout this disclosure, the historical data may include impressions, purchases, registrations, subscriptions, clicks, costs, orders, and/or conversions associated with the one or more keywords. The historical data may be representative of revenue events generated from advertising instances (e.g., a displayed advertisement, a displayed webpage, a displayed search result, a promoted webpage, and so forth) associated with the one or more keywords 202. The historical data may be obtained from any data source or tracking/analytics tool, e.g., the advertiser 116, the search engine provider 118, the monitoring service 120, a remote database, and so forth.

The first model 204 may obtain historical data for a short tail keyword and a long tail keyword. Alternatively, the first model 204 may obtain, from different data sources, multiple sets of historical data for the short tail keyword and/or the long tail keyword. Here, each set of historical data may be used to produce a revenue model. And in this case, the first model 204 will contain multiple models each corresponding to one source of data.

As further illustrated, the second model 206 may obtain online behavior data associated with the one or more keywords. In examples when the one or more keywords includes at least two keywords, the second model 206 may obtain online behavior data for a subset (e.g., less than all) of the at least two keywords. Generally, online behavior data may be representative of user navigation, website engagement, and/or user purchase behavior. As used throughout this disclosure, behavior data (e.g., online behavioral data) may include data indicative of time spent on webpage (e.g., time spent for a first site visit or time spent in total over a given time period, such as a day), webpage viewed (e.g., per visit or over a given time period), bounce rate, and so forth. Online behavior data includes data indicative of page views per visit, time spent on site, and bounce rate associated with the one or more keywords 202. In some examples, the online behavior data may not be directly associated with the one or more keywords 202, but instead be derived from data tracking general user purchase behavior. The online behavior data may also take the form of label data or categorical data.

As previously mentioned, historical data and online behavior data may be obtained from multiple data sources. For instance, the historical data may be obtained from an analytics tool, a third party analytics tool, an analytics application, and so forth. Meanwhile the online behavior data may be obtained from an analytics tool, a tracking application, a user profile, and the like.

The ensemble model 104 may be formed from the first model 204 and the second model 206. Without loss of generality, only two models are considered here as an example, however, in another example, the ensemble model 104 may be formed from more than two models. The ensemble model 104 may be configured such that weights are assigned to the first model 204 and the second model 206 using any of the techniques described herein. For example, for keywords with rich historical data, the weighing module 106 may assign a higher weight to the first model 204 relative to the second model 206. Alternatively, for keywords with spare historical data, such as long tail keywords, the weighing module 106 may assign a lower weight to the first model 204 relative to the second model 206. Accordingly, the ensemble model 104 may be utilized to predict revenue metrics 208 for the one or more keywords 202 even in instances in which data utilized to generate the first model 204 is sparse.

Various actions such as obtaining, generating, forming, predicting, assigning, and so forth performed by various modules are discussed herein. It should be appreciated that the various modules may be configured in various combinations with functionality to cause these and other actions to be performed. Functionality associated with a particular module may be further divided among different modules and/or the functionality represented by multiple modules may be combined together into a single logical module. Moreover, a particular module may be configured to cause performance of action directly by the particular module. For example, the weighing module 106 may be separate from the ensemble model 104. In addition or alternatively the particular module may cause particular actions by invoking or otherwise accessing other components or modules to perform the particular actions (or perform the actions in conjunction with that particular module).

Example Procedures

The following discussion describes ensemble model techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. Moreover, any one or more blocks of the procedure may be combined together or omitted entirely in different implementations. Moreover, blocks associated with different representative procedures and corresponding figures herein may be applied together. Thus, the individual operations specified across the various different procedures may be used in any suitable combinations and are not limited to the particular combinations represented by the example figures. In portions of the following discussion, reference may be made to the examples of FIGS. 1 and 2.

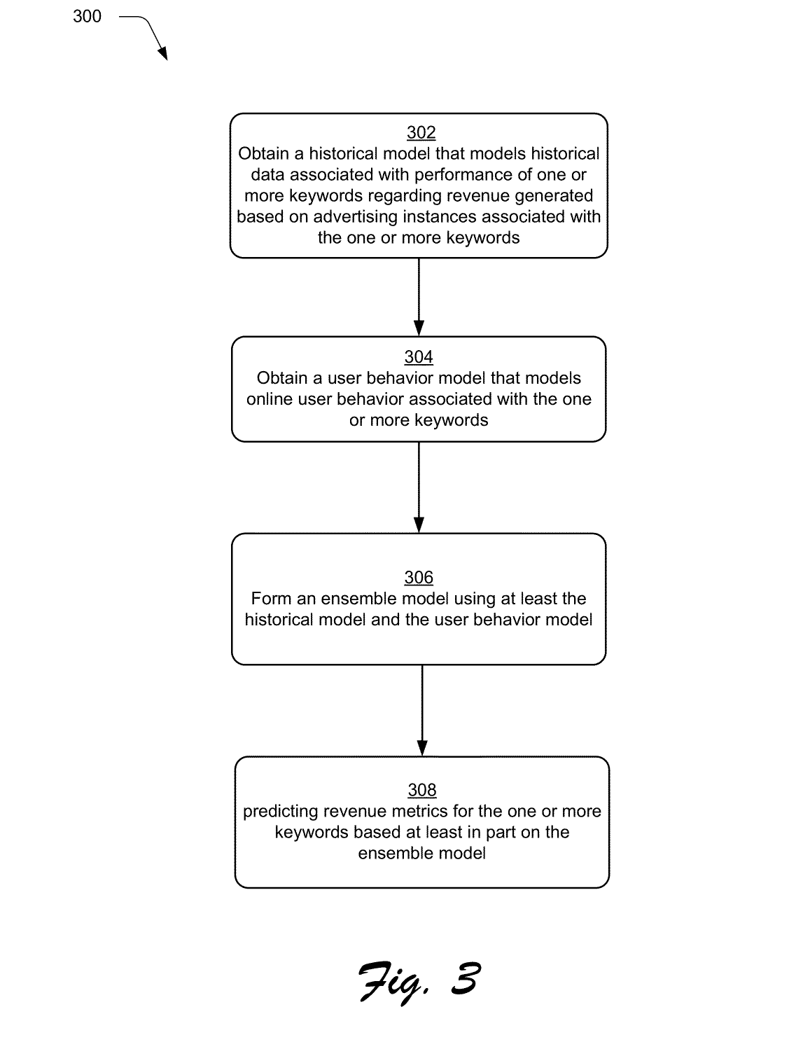

FIG. 3 is a flow diagram depicting a procedure 300 in which the ensemble model predicts revenue metrics for the one or more keywords. In at least some implementations, procedure 300 may be performed by a suitably configured computing device such as computing device 102 of FIG. 1 having an ensemble model 104 or as described in relation to FIG. 6.

A historical model is obtained that models historical data associated with performance of one or more keywords regarding revenue generated based on advertising instances associated with the one or more keywords (block 302). For example, the computing device 102 may obtain the historical model using any of the techniques described herein. In one or more implementations, the one or more keywords are entered as a search query in a search engine.

A user behavior model is also obtained that models online user behavior associated with the one or more keywords (block 304). For instance, the computing device 102 may obtain the user behavior model using any of the techniques described herein. In one or more implementations, data associated with the user behavior model is obtained from a different data source as the historical data of the historical model.

An ensemble model is formed using at least the historical model and the user behavior model (block 306). For instance, the user behavior model may be combined with the historical model to form the ensemble model 104, examples of which are described previously. In at least some implementations, the user behavior model and the historical model are each configured for use in predicting revenue values for the one or more keywords. The predicted revenue values from each model may be weighted based on a confidence value indicative of a likelihood of accuracy of each predicted revenue value.

Revenue metrics are predicted for the one or more keywords based at least in part on the ensemble model (block 308). For instance, predicted revenue metrics are generated by the ensemble model 104 based on the weights assigned to the user behavior model and the historical model. In at least some implementations, the predicted revenue metrics are generated by the ensemble model 104 based on the weighted prediction value of the user behavior model and the weighted prediction value of the historical model.

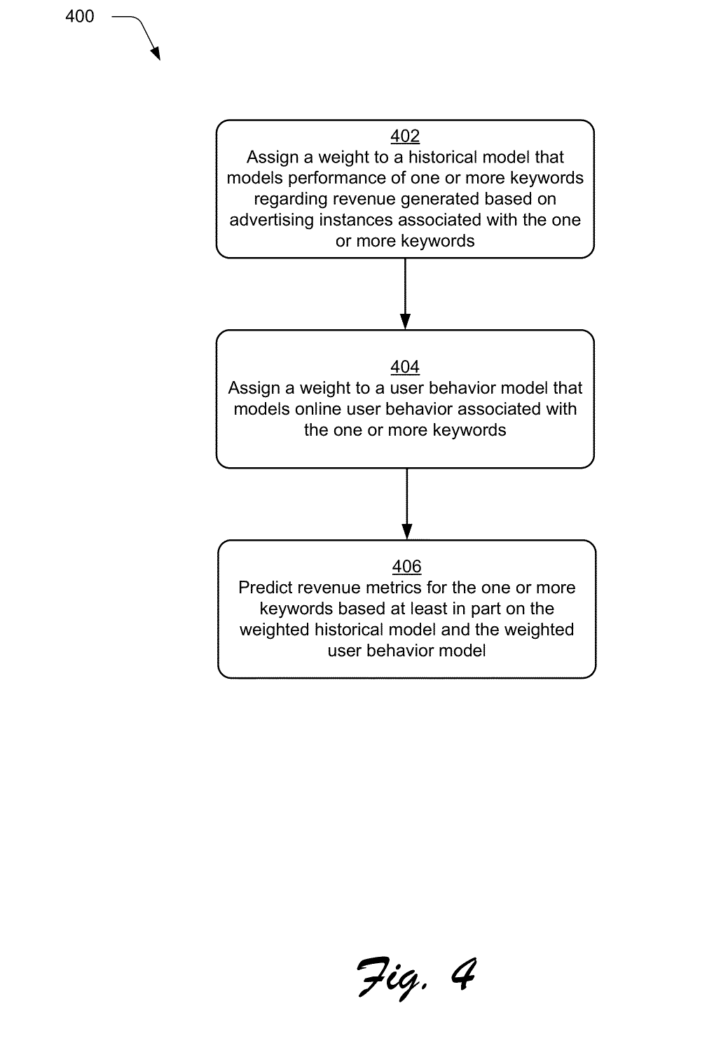

Having considered an example procedure in which the ensemble model predicts revenue metrics for the one or more keywords, consider now a procedure 400 in FIG. 4 that depicts an example for predicting revenue metrics for one or more keywords based at least in part on a weighted historical model and a weighted user behavior model. In at least some implementations, procedure 400 may be performed by a suitably configured computing device such as computing device 102 of FIG. 1.

A weight is assigned to a historical model that models performance of one or more keywords regarding revenue generated based on advertising instances associated with the one or more keywords (block 402). For example, the weighing module 106 assigns a weight to the historical model based on sparsity (e.g., a sparsity value) of historical data used to form the historical model, an amount of available historical data, and/or a confidence value indicative of a likelihood of accuracy of the historical data. In one or more implementations, the weighing module 106 is separate from the ensemble model 104 such that the weight is assigned independent of the ensemble model 104.

A weight is assigned to a user behavior model that models online user behavior associated with the one or more keywords (block 404). For example, the weighing module 106 assigns a weight to the historical model based on sparsity of historical data used to form the historical model, an amount of available historical data, and/or a confidence value indicative of a likelihood of accuracy of the historical data. In at least some implementations, if the amount of available historical data is below a threshold, or the historical data is determined to not be particularly useful based on the confidence value, then a lower weight may be assigned to the historical model relative to the weight assigned to the user behavior model.

Revenue metrics are predicted for the one or more keywords based at least in part on the weighted historical model and the weighted user behavior model (block 406). For example, the prediction module 110 may predict the revenue metrics for the one or more keywords by applying common statistical algorithms, such as bagging or bootstrap aggregating, to integrate the weighted historical model and the weighted user behavior model. In at least some implementations, the prediction module 110 may be separate from the ensemble model 104 such that the revenue metrics are predicted independent of the ensemble model 104.

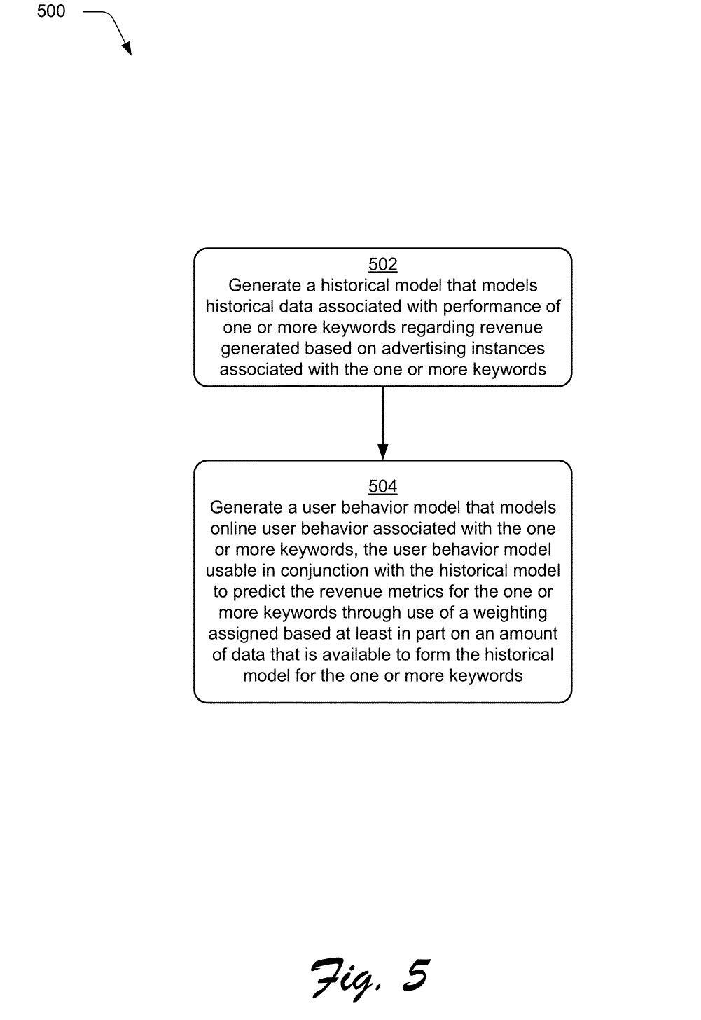

Having considered an example procedure that depicts predicting revenue metrics for one or more keywords based at least in part on a weighted historical model and a weighted user behavior model, consider now a procedure 500 in FIG. 5 that depicts an example for a procedure in which a user behavior model and a historical model are generated to predict revenue metrics for one or more keywords. In at least some implementations, procedure 500 may be performed by a suitably configured computing device such as computing device 102 of FIGS. 1 and/or 6.

A historical model is generated that models historical data associated with performance of one or more keywords regarding revenue generated based on advertising instances associated with the one or more keywords (block 502). For example, the ensemble model 104 may generate the historical model by obtaining historical data from a data source. In some examples, the historical data may include numerical data indicative of impressions, clicks, costs, and/or conversions associated with performance of one or more keywords. The historical model may be usable to predict revenue metrics for the one or more keywords.

A user behavior model is generated that models online user behavior associated with the one or more keywords (block 504). For example, the ensemble model 104 may generate the online user behavior model by obtaining behavioral data from a data source. In one or more implementations, the behavioral data and the historical data are obtained from different data sources.

The user behavior model is usable in conjunction with the historical model to predict the revenue metrics for the one or more keywords through use of a weighting (block 506). For example, the ensemble model 104 may assign weights to the user behavior model and the historical model using any of the examples provided in this disclosure. The assigned weights may be based on an amount of data that is available to form the historical model for the one or more keywords.

Example System and Device

FIG. 6 illustrates an example system 600 that, generally, includes an example computing device 602 that is representative of one or more computing systems and/or devices that may implement the various techniques described herein. This is illustrated through inclusion of the ensemble model 104. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors, e.g., electronic integrated circuits (ICs). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media, e.g., Flash memory, a removable hard drive, an optical disc, and so forth. The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in one or more implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract scaling of resources to provide a corresponding level of scale to encountered demand for the resources 618 that are implemented via the platform 616. Accordingly, in an interconnected device embodiment, implementation of functionality described herein may be distributed throughout the system 600. For example, the functionality may be implemented in part on the computing device 602 as well as via the platform 616 that abstracts the functionality of the cloud 614.

Conclusion

Although the techniques have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter.

1. A method implemented by a computing device, the method comprising:
generating, by the computing device, a historical model that models historical data associated with performance of one or more keywords regarding revenue generated based on online advertising instances associated with the one or more keywords;
generating, by the computing device, a user behavior model that models online user behavior associated with the one or more keywords;
forming, by the computing device, an ensemble model using a weighted prediction of the historical model and a weighted prediction of the user behavior model;
predicting, by the computing device, revenue metrics for the one or more keywords based at least in part on the ensemble model; and
communicating, by the computing device, the predicted revenue metrics to an advertiser.

2. A method as described in claim 1, wherein the one or more keywords are associated with use as a search query in a search engine.

3. A method as described in claim 1, wherein the online advertising instances include promoting a webpage in search results or presenting an advertisement.

4. A method as described in claim 1, further comprising concurrently obtaining data associated with the historical model and data associated with the user behavior model from multiple different sources.

5. A method as described in claim 1, further comprising assigning the weight to the prediction of the historical model based, at least in part, on a sparsity value.

6. A method as described in claim 5, wherein the sparsity value indicates usefulness of the historical model to predict the performance of the one or more keywords.

7. A method as described in claim 1, wherein the user behavior model that models the online user behavior associated with the one or more keywords obtains data from multiple different sources.

8. A system comprising:
one or more modules implemented at least partially in hardware, the one or more modules configured to perform operations comprising:
assigning a weight to a historical model that models performance of one or more keywords regarding revenue generated based on online advertising instances associated with the one or more keywords, the weight assigned to the historical model being based at least in part on sparsity of the historical data used to form the historical model;
assigning a weight to a user behavior model that models online user behavior associated with the one or more keywords, the weight assigned to the user behavior model being based at least in part on the sparsity of the historical data used to form the historical model;
predicting revenue metrics for the one or more keywords based at least in part on the weighted historical model and the weighted user behavior model; and
providing the predicted revenue metrics to an advertiser.

9. A system as described in claim 8, wherein the one or more modules are further configured to combine the historical model and the user behavior model into an ensemble model such that the ensemble model performs the predicting.

10. A system as described in claim 9, wherein the ensemble model is not a Bayesian model.

11. A system as described in claim 8, wherein the weight assigned to the historical model is further based at least in part on an accuracy factor of the historical model for predicting potential revenue of the one or more keywords.

12. A system as described in claim 8, wherein the historical model includes historical revenue data obtained from a first data source and the user behavior model includes behavioral data obtained from a second data source.

13. A system as described in claim 8, the one or more modules further configured to concurrently access, over a computer network, multiple data sources such that historical revenue data used to form the historical model is collected from one of the multiple data sources and behavior data used to form the historical model is collected from another of the multiple data sources.

14. A method implemented by a computing device, the method comprising:
generating, by the computing device, a historical model that models historical data associated with performance of one or more keywords regarding revenue generated based on advertising instances associated with the one or more keywords, the historical model usable to predict revenue metrics for the one or more keywords;
generating, by the computing device, a user behavior model that models online user behavior data associated with the one or more keywords, the user behavior model usable in conjunction with the historical model to predict the revenue metrics for the one or more keywords through use of a weighting assigned based at least in part on an amount of data that is available to form the historical model for the one or more keywords; and
outputting, by the computing device, a prediction result for the one or more keywords using the historical model and the user behavior model.

15. A method as described in claim 14, wherein the online user behavior data and the historical data are obtained from different data sources.

16. A method as described in claim 15, wherein the historical data includes numerical data and the behavioral data includes categorical data.

17. A method as described in claim 15, wherein the online user behavior data includes data describing bounce rate, time spent on-site, or page views.

18. A method as described in claim 14, wherein the weighting assigned is further based at least in part on a confidence value indicative of a likelihood of accuracy of the historical data.

19. A method as described in claim 14, further comprising forming an ensemble model using at least the historical model and the user behavior model.

20. A method as described in claim 14, wherein the one or more keywords includes at least two keywords and further comprising collecting the online user behavior data for a subset of the at least two keywords.
